(19) United States
(12) Patent Application Publication
(10) Pub. No.: US 2008/0303771 A1
(43) Pub. Date: Dec. 11, 2008

(54) DISPLAY AND TWO STEP DRIVING METHOD THEREOF

(75) Inventors: Ying-Lieh Chen, Tainan County (TW); Lin-Kai Bu, Tainan County (TW); Chien-Ru Chen, Tainan County (TW); Chih-Hsing Chang, Tainan County (TW); Wen-Tsung Lin, Tainan County (TW); Yung-Yu Tsai, Tainan County (TW); Yung-Li Huang, Tainan County (TW)

Correspondence Address: J C PATENTS, INC., 4 VENTURE, SUITE 250, IRVINE, CA, 92618, US

(73) Assignees: HIMAX TECHNOLOGIES LIMITED, Tainan County (TW); CHI MEI OPTOELECTRONICS CORPORATION, Tainan County (TW)

(21) Appl. No.: 11/839,297

(22) Filed: Aug. 15, 2007

(30) Foreign Application Priority Data
Jun. 5, 2007 (TW) 96120076

(51) Int. Cl. G09G 3/36

(52) U.S. Cl. 345/94; 345/87

(57) ABSTRACT

A display and a two step driving method thereof are provided. The method includes: converting an image signal to a corresponding data driving voltage by using a driver; providing a pre-driving voltage by using a voltage generator; and finally, driving the display panel by using the pre-driving voltage and data driving voltage orderly during a horizontal synchronizing period. A display includes a display panel, a voltage generator, and a driver. The display panel also includes at least one data line. The voltage generator outputs a pre-driving voltage to the data line of the display. The driver outputs a data driving voltage to the data line according to an image signal, in which the data line receives the pre-driving voltage and the data driving voltage orderly during the horizontal synchronizing period.

### CROSS-REFERENCE TO RELATED APPLICATION

This application claims the priority benefit of Taiwan application serial no. 96120076, filed on Jun. 5, 2007. All disclosure of the Taiwan application is incorporated herein by reference.

### BACKGROUND OF THE INVENTION

1. Field of the Invention

The present invention relates to a display apparatus. More particularly, the present invention relates to a two step driven display apparatus and a method thereof.

2. Description of Related Art

Flat panel display apparatus, e.g. thin film transistor-liquid crystal display (TFT-LCD), has been proposed to serve as a replacement of a conventional cathode ray tube (CRT) display apparatus. As compared with the conventional CRT display, the TFT-LCD apparatus has advantages such as having relatively low voltage action, low power consumption, thin and small size, and light weight.

FIG. 1A shows a conventional LCD 100. The display 100 includes a control board (X-board) 102, a Gamma reference voltage generator 104, a timing controller 106, a plurality of source driver units 120 and 121, and a display panel 130. Each source driver unit (e.g. the source driver unit 120) respectively includes an interface circuit 122, a digital-analog converter (DAC) 124, and an output buffer 126. The conventional LCD 100 uses the Gamma reference voltage generator 104 on the control board 102 to generate a reference voltage, and to transmit the reference voltage to the DAC in the source driver units 120 and 121. The operation detail of each source driver unit is known by those skilled in the art, so it is not described here.

The display panel 130 has a plurality of data lines (for example data lines 136 and 137). Each data line is respectively coupled to a plurality of sub-pixel units (here only sub-pixel units 139 and 140 are shown). One group of the sub-pixel units connected by the data line 136 includes a transistor 132 and a liquid crystal capacitor 134. The logic state of the transistor 132 is controlled through the signal of a corresponding scan line 131, and the source driver unit 120 can store the charge signal in the capacitor 134. The capacitor 134 stores the data of the data line 136 based on the common voltage Vcom, and the transmittance of the sub-pixel unit is determined by the potential difference of the two ends of the liquid crystal capacitor 134. FIG. 1B is a signal timing diagram illustrating an even data line and an odd data line (here the data line 136 and the data line 137 are used for illustration) in FIG. 1A. The conventional large panel mostly adopts the direct current (DC) common voltage Vcom design, so the data lines 136 and 137 of the display panel 130 have a negative polarity voltage (represented by ) lower than the common voltage Vcom, and a positive polarity voltage (represented by ) higher than the common voltage Vcom. The data line is alternatively driven by the positive polarity voltage and the negative polarity voltage. For example, the voltage swing of the voltage V136 of the data line 136 is SW1A, and the voltage swing of the voltage V137 of the data line 137 is SW1B, as shown in FIG. 1B. The voltage swing width is related to the consumed power magnitude. However, according to the conventional method, the voltage swing at the source driver unit 120 is too large and the consumed power is too large, and the temperature of the source driver unit 120 is too high.

In order to solve the problem that the consumed power of the source driver unit 120 is too large, FIG. 1C shows a conventional display 150 which includes a charge sharing circuit for reducing the swing of the voltage used to drive the corresponding data line by the source driver unit (for example source driver units 160 and 170). The display 150 in FIG. 1C includes a control board 152, a Gamma reference voltage generator 154, a timing controller 156, a plurality of source driver units (for example the source driver unit 160 and the source driver unit 170), a switch 172, a switch 174, a switch 176, and a display panel 180. Each source driver unit (for example the source driver unit 160) includes an interface circuit 162, a DAC 164, and an output buffer 166. In the LCD 150, the Gamma reference voltage generator 154 generates a reference voltage on the control board 152, and transmits the reference voltage to the DACs of the source driver units 160 and 170, such that the source driver units 160 and 170 output voltages V186 and V187.

FIG. 1D is a signal timing diagram of an even data line and an odd data line (here the data line 186 and the data line 187 are used for illustration) in FIG. 1C. In a charge sharing period t1, the switch 172 and the switch 176 are in the OFF state, and the switch 174 is in the ON state, so the charging sharing is generated between the data lines 186 and 187 due to short circuit. Therefore, in the charge sharing period t1, the voltage V186 of the data line 186 and the voltage V187 of the data line 187 converge to approximately the common voltage Vcom, and this is the operation of the charge sharing. After the charge sharing period t1 is end, the process proceeds to a normal driving period t2, at this time, the switch 172 and the switch 76 are in the ON state, and the switch 174 is in the OFF state, such that the source driver units 160 and 170 can drive the data lines 186 and 187. The detail of the driving operation is known by those skilled in the art, so it is not described here.

It is known from FIG. 1D that by the operation of the charge sharing, in the charge sharing period t1, the voltage level on the data line 186 is drawn to the common voltage Vcom in advance. Therefore, in the normal driving period t2, the swing SW1C of the voltage of the source driver unit 160 for driving the data line 186 is reduced. After the normal driving period t2 is end, the process proceeds to a charge sharing period t3, and the internal circuit of the display 150 begins to perform the charge sharing operation again, so as to repeatedly perform the same activity. Though the operation of the charge sharing, the swing of the voltage of the source driver unit for driving the data line can be greatly reduced, thereby reducing the power consumption of the source driver unit, and achieving the function of power saving. However, the voltage swing reduced by the circuit operation mode with the charge sharing action is still limited, and it is impossible to obtain the minimum power consumption of the source driver unit.

### SUMMARY OF THE INVENTION

Accordingly, the present invention is directed to provide a two step driving voltage display, capable of performing two step driving in the display to save the power consumption in the driver unit and to lower the operation temperature of the driver unit.

The present invention also provides a two step method of driving the voltage, capable of providing a pre-driving voltage by a voltage generator to lower the power consumption and the temperature of the driver unit.

In order to solve the problems of the prior art, the present invention provides a display, which includes a display panel, a voltage generator, and a driver unit. The display panel also includes at least one data line. The voltage generator outputs the pre-driving voltage to the data line of the display. The driver unit outputs a data driving voltage to the data line according to the image signal. The data line receives the pre-driving voltage and the data driving voltage orderly in a horizontal synchronizing period.

The present invention further provides a two step driving method for driving a display panel. The method includes converting the image signal to the corresponding data driving voltage by using the driver unit; generating the pre-driving voltage by using the voltage generator; and finally, driving the display panel by using the pre-driving voltage and the data driving voltage orderly in a horizontal synchronizing period.

The display and the two step driving method provided by the present invention can reduce the driving voltage swing of the driver unit, such that the power consumption of the driver unit is reduced, and the temperature on the driver unit is also reduced.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view of a conventional display.

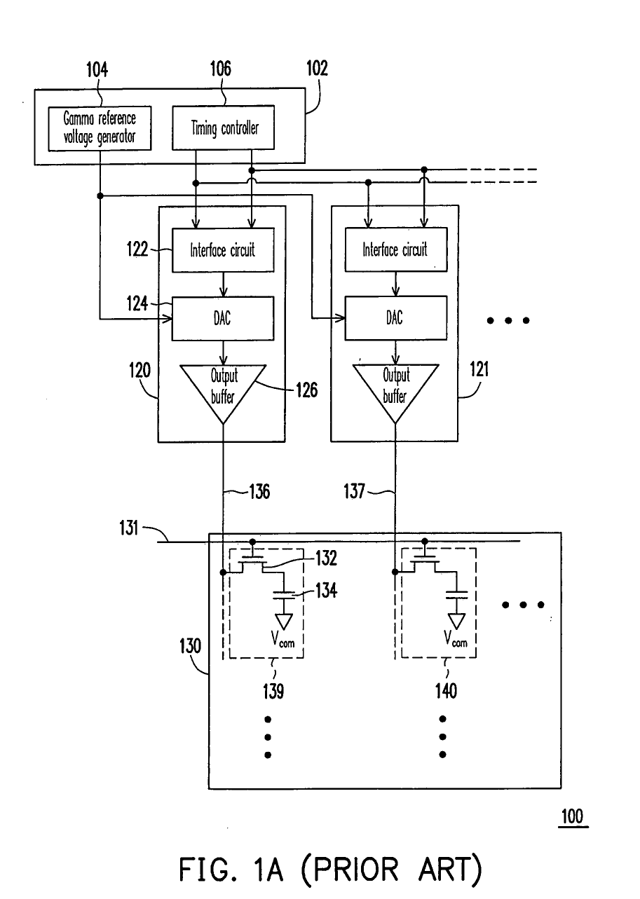

FIG. 1B is a signal timing diagram of an even data lines and an odd data lines in FIG. 1A.

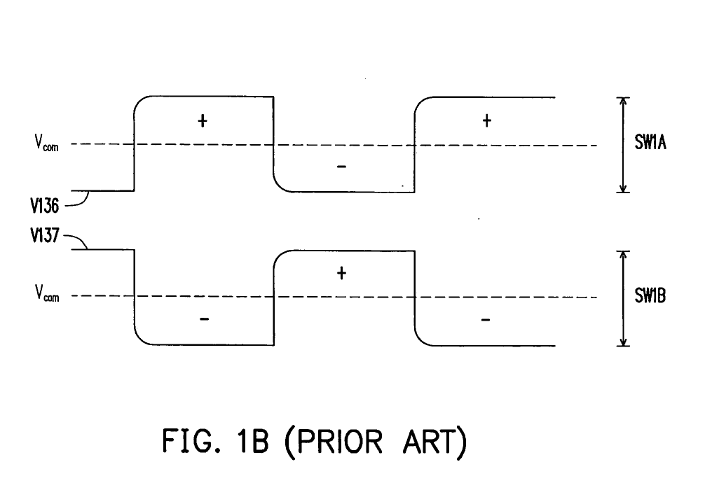

FIG. 1C is a schematic view of another display.

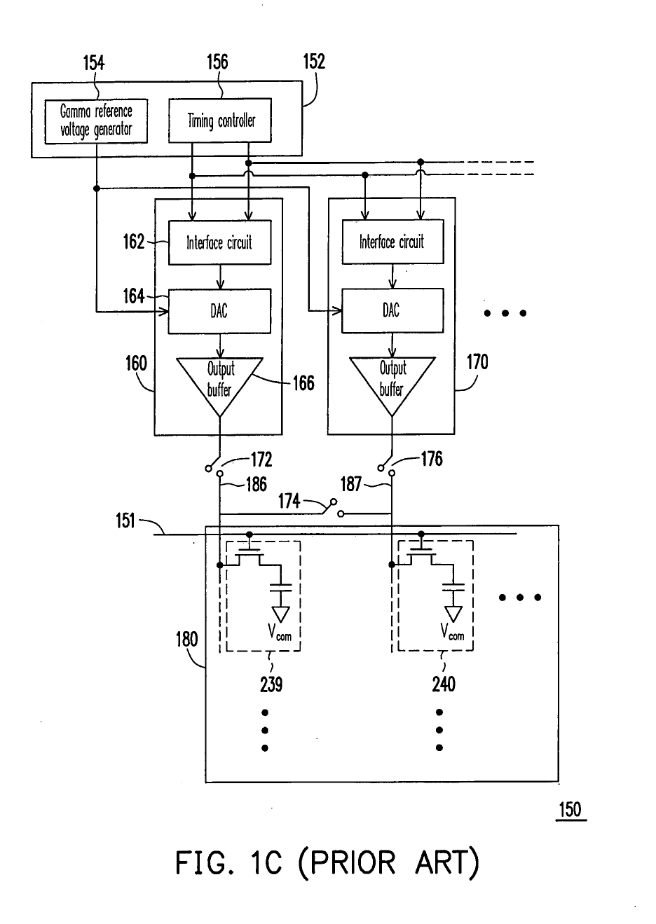

FIG. 1D is a signal timing diagram of an even data line and an odd data line in FIG. 1C.

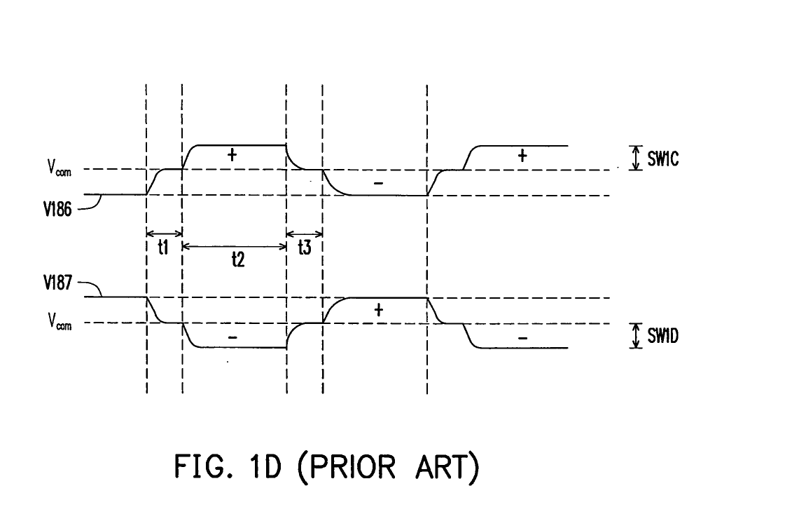

FIG. 2A is a circuit block diagram of a two step driven display according to an embodiment of the present invention.

FIG. 2B is a signal timing diagram of an even data line and an odd data line in FIG. 2A according to the embodiment of the present invention.

FIG. 3 is a circuit block diagram of a two step driven display according to another embodiment of the present invention.

FIG. 4 is a circuit block diagram of a two step driven display circuit according to another embodiment of the present invention.

FIG. 5 is a circuit block diagram of a two step driven display circuit according to another embodiment of the present invention.

FIG. 6 is a circuit block diagram of a two step driven display circuit according to another embodiment of the present invention.

FIG. 7 is a circuit block diagram of a two step driven display circuit according to another embodiment of the present invention.

### DESCRIPTION OF EMBODIMENTS

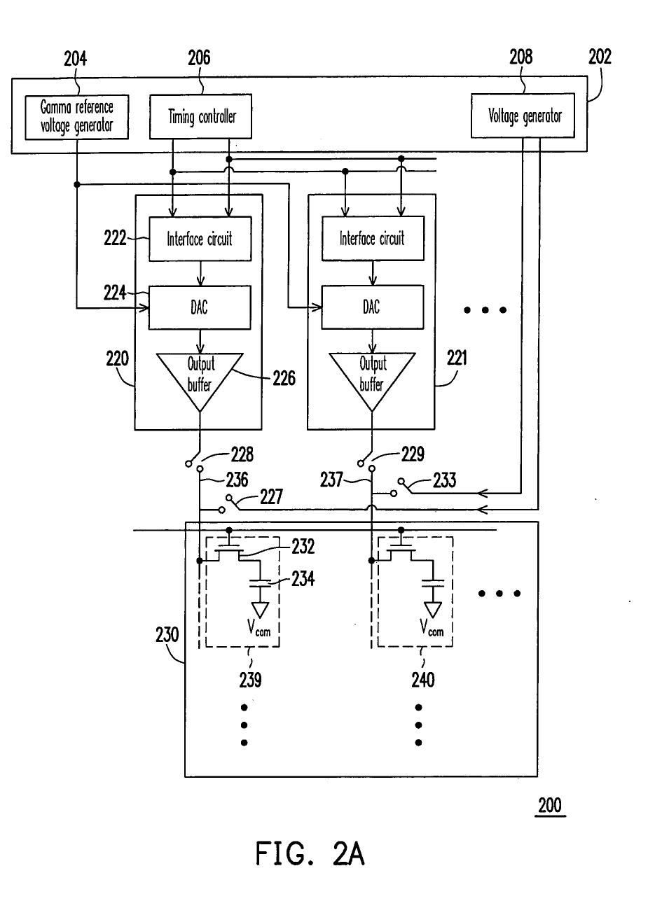

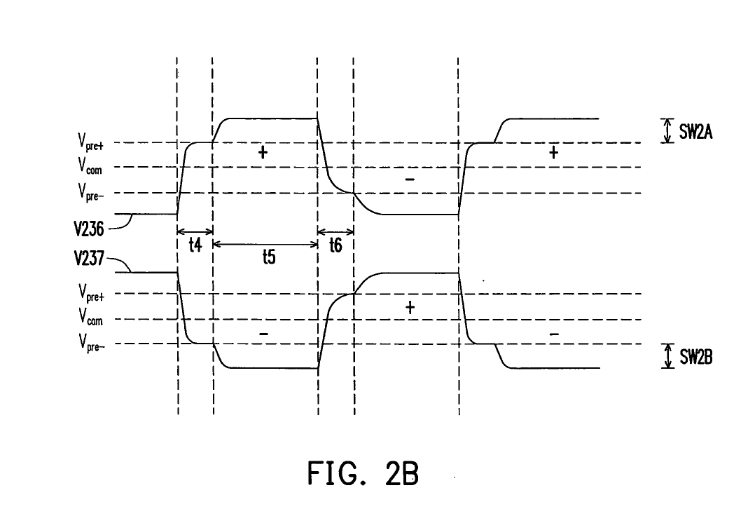

FIG. 2A is an embodiment of a two step driving voltage display according to the present invention. Referring to FIG. 2A, a display 200 includes a control board 202, a Gamma reference voltage generator 204, a timing controller 206, a voltage generator 208, a plurality of source driver units (for example source driver units 220 and 221), a switch 227, a switch 228, a switch 229, a switch 233, and a display panel 230. Each source driver unit (for example the source driver unit 220) respectively includes an interface circuit 222, a DAC 224, and an output buffer 226. The Gamma reference voltage generator 204 is used to generate a reference voltage and to transmit the reference voltage to the DAC of the source driver unit. The timing controller 206 in the control board 202 outputs a control signal and an image signal to each source driver unit 220 and 221.

The operation detail of each source driver unit is known by those skilled in the art, so it is not further described here. The display 230 has a plurality of data lines (for example data lines 236 and 237) and a plurality of scan lines (for example a scan line 231). Each data line is respectively coupled to a plurality of sub-pixel units (here only sub-pixel units 239 and 240 are shown). One group of the sub-pixel units 239 connected by the data line 236 includes a transistor 232 and a liquid crystal capacitor 234. A signal of the corresponding scan line 231 is used to control the transistor 232, such that the source driver unit 220 stores the data driving voltage in the capacitor 234. The capacitor 234 stores the data of the data line 236 based on the common voltage Vcom, and the transmittance of the sub-pixel unit 239 is determined by the potential difference between two ends of the liquid crystal capacitor 234.

The voltage generator 208 can output the pre-driving voltage to the data lines 236 and 237 of the display 200 through the switches 227 and 233. The driver units 220 and 221 convert the image signal output by the timing controller 206 to the corresponding data driving voltage, and output the data driving voltage to the data lines 236 and 237 through the switches 228 and 229. By controlling the switches 227, 228, 229, and 233, the display panel 230 is driven by the pre-driving voltage and the data driving voltage orderly in a horizontal synchronizing period, such that the data lines 236 and 237 receive the pre-driving voltage and the data driving voltage orderly in the horizontal synchronizing period.

FIG. 2B is a signal timing diagram of the even data line 236 and the odd data line 237 in FIG. 2A according to the embodiment of the present invention. Referring to FIGS. 2A and 2B, in a pre-driving period t4, the first switches 228 and 229 are in the OFF state, and the second switches 227 and 233 are in the ON state. At this time, the voltage generator 208 outputs a positive polarity pre-driving voltage Vpre+ to the data line 236 through the switch 227, and the voltage generator 208 also outputs a negative polarity pre-driving voltage Vpre− to the data line 237 through the switch 233. Therefore, in the pre-driving period t4, the voltage V236 on the data line 236 pre-rises to the pre-driving voltage Vpre+, and the voltage V237 on the data line 237 pre-lowers to the pre-driving voltage Vpre−. The person applying the present invention can determine the levels of the pre-driving voltages Vpre+ and Vpre− according to the requirement. For example, the levels of the pre-driving voltages Vpre+ and Vpre− can be set to the level the same as the common voltage Vcom. Alternatively, the level of the pre-driving voltage Vpre+ can be set to the level the same as a reference voltage of the positive polarity Gamma reference voltage, and the level of the pre-driving voltages Vpre− can be set to the level the same as a reference voltage of the negative polarity Gamma reference voltage. Alternatively, the pre-driving voltage Vpre+can be set as the minimum positive polarity driving voltage on the scan line, and the pre-driving voltage Vpre− can be set as the maximum negative polarity driving voltage on the scan line.

After the pre-driving period t4 is end, the process proceeds to a data driving period t5. In the data driving period t5, the first switches 228 and 229 are in the ON states, and the second switches 227 and 233 are in the OFF state. At this time, the source driver units 220 and 221 convert the image signal output by the timing controller 206 to the corresponding data driving voltages, and respectively output the data driving voltages to the data lines 236 and 237. Therefore, the voltage V236 on the data line 236 and the voltage V237 on the data line 237 are driven to the level of the data driving voltage. Therefore, in the data driving period t5, it is only necessary for the source driver unit 220 to change the voltage of the data line 236 from the pre-driving voltage Vpre+ to the data driving voltage, and the changed voltage swing SW2A is greatly reduced as compared with the conventional art (similarly, the swing SW2B of the voltage of the source driver unit 221 for driving the data line 237 is also greatly reduced), thereby reducing the power consumption of the driver units 220 and 221, so as to reduce the operation temperature of the driver units 220 and 221.

After the data driving period t5 is end, it begins to input data to the pixels on the next scan line. Firstly, the process proceeds to a pre-driving period t6. In the pre-driving period t6, the first switches 228 and 229 are in the OFF state, and the second switches 227 and 233 are in the ON state. At this time, the voltage generator 208 outputs the negative polarity pre-driving voltage Vpre− to the data line 236 through the switch 227, and the voltage generator 208 also outputs the positive polarity pre-driving voltage Vpre+ to the data line 237 through the switch 233. Therefore, in the pre-driving period t6, the voltage V236 on the data line 236 pre-lowers to the pre-driving voltage Vpre−, and the voltage V237 on the data line 237 pre-rises to the pre-driving voltage Vpre+, so as to repeatedly perform the same activity.

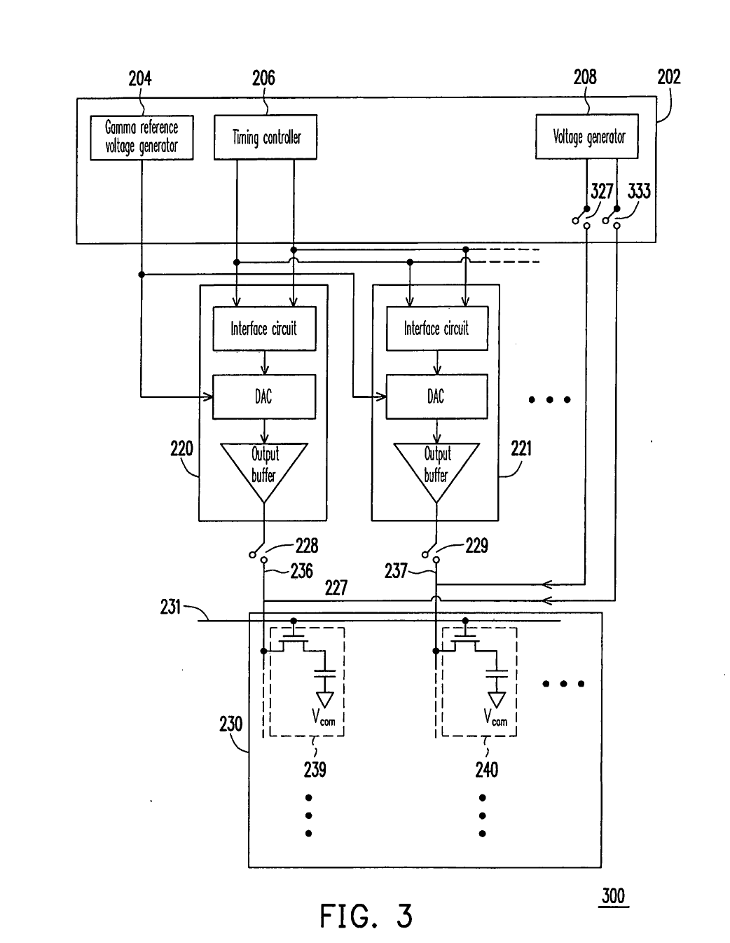

FIG. 3 is another embodiment of a two step driving voltage display according to the present invention. The display 300 of this embodiment is similar to the display 200 of FIG. 2A, so the implementing detail is not described. The difference between the display 300 and the display 200 is the implementation of the second switches 327 and 333. In the display 200 of FIG. 2A, the second switches 227 and 233 and the driver units 220 and 221 are implemented in the same source driver integrated circuit (IC). In the display 300 of FIG. 3, the second switches 327 and 333 are implemented on the control board 202.

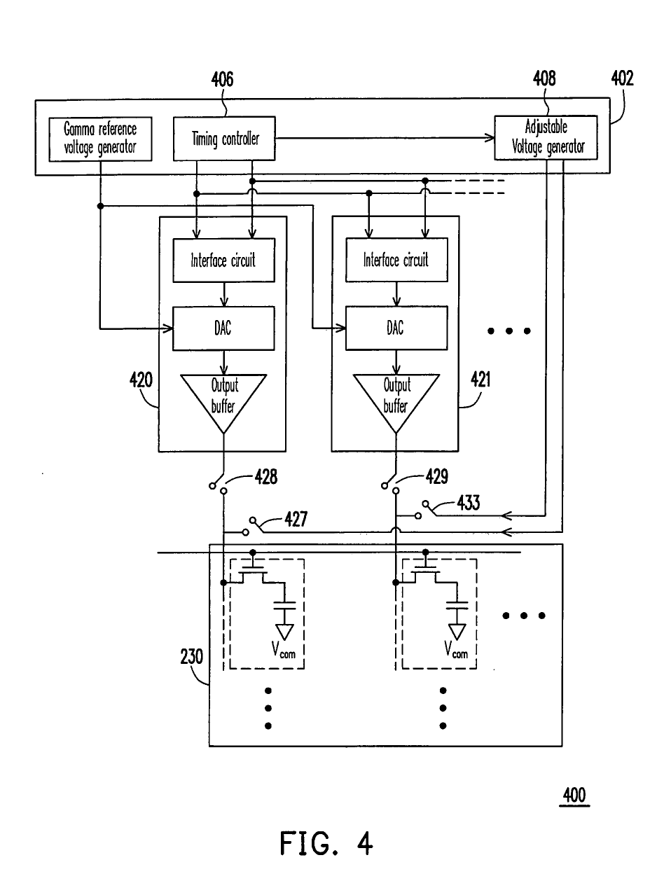

FIG. 4 is another embodiment of a two step driving voltage display according to the present invention. The display 400 of this embodiment is similar to the display 200 of FIG. 2A, so the implementing detail is not described. The difference between the display 400 and the display 200 is the implementation of the voltage generator 408. The voltage output by the voltage generator 208 in FIG. 2A is a preset fixed voltage, and a voltage generator 408 in this embodiment is an adjustable voltage generator. Referring to FIGS. 2B and 4, a timing controller 406 provides the image signal to driver units 420 and 421. The timing controller 406 can provide the most suitable signal to the voltage generating unit 408 after calculation, such that the voltage generating unit 408 correspondingly outputs the preferred positive polarity pre-driving voltage Vpre+ and negative polarity pre-driving voltage Vpre−. Alternatively, the timing controller 406 can output the minimum value in the image signal to the voltage generating unit 408 in the horizontal synchronizing period, such that the voltage generating unit 408 corresponding outputs the positive polarity pre-driving voltage Vpre+ and the negative polarity pre-driving voltage Vpre−. In this embodiment, the voltage generating unit 408 can be realized by the DAC, for converting the output of the timing controller 406 to the positive polarity pre-driving voltage Vpre+ and the negative polarity pre-driving voltage Vpre−. Therefore, the level of the pre-driving voltage may further approach the level of the data driving voltage, such that the swing of the voltage of the source driver unit for driving the data line is greatly reduced, thereby reducing the power consumption of the driver unit, so as to reduce the operation temperature of the driver unit.

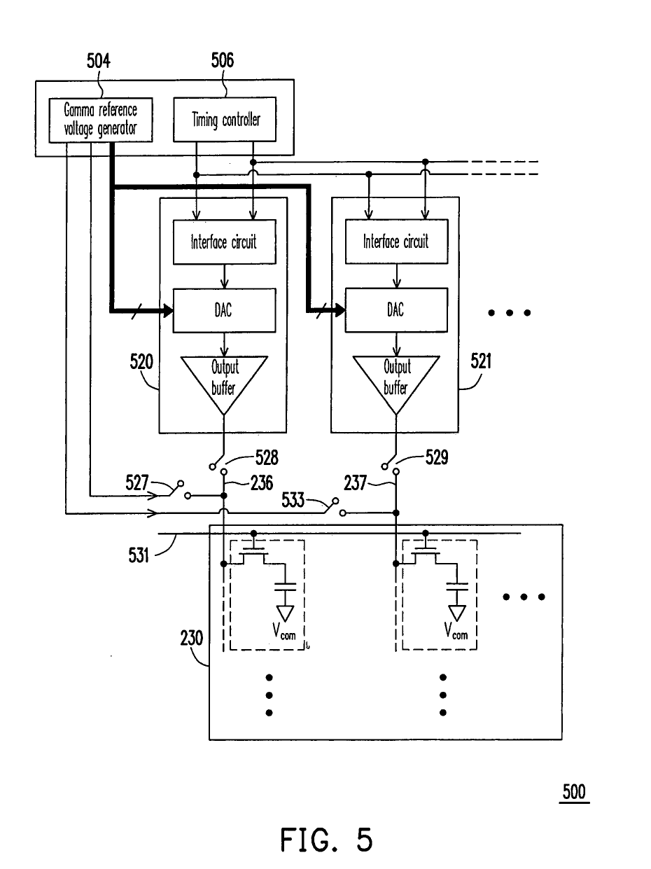

FIG. 5 is another embodiment of a two step driving voltage display according to the present invention. The display 500 of this embodiment is similar to the display 200 of FIG. 2A, so the implementing detail is not described. The difference between the display 500 and the display 200 is the implementation of the voltage generator. In the display 200 in FIG. 2A, an additional voltage generator 208 is disposed to provide the pre-driving voltage, and in the display 500 of this embodiment, an existing Gamma reference voltage generator 504 is used to realize the voltage generator.

Referring to FIGS. 2B and 5, a timing controller 506 provides the image signal to driver units 520 and 521. The Gamma reference voltage generator 504 provides a plurality of Gamma reference voltages representing different gray levels to the driving units 520 and 521. The driver units 520 and 521 generate the data driving voltage (for driving the data line) according to the image signal and the Gamma reference voltage. The Gamma reference voltage generator 504 further outputs one of the plurality of Gamma reference voltages as the pre-driving voltage. Here, the driving method of polarity inversion is set as an example, the Gamma reference voltage generator 504 outputs one in the positive polarity Gamma reference voltage group as the positive polarity pre-driving voltage Vpre+, and outputs one in the negative polarity Gamma reference voltage group as the negative polarity pre-driving voltage Vpre−. In the pre-driving period t4, first switches 528 and 529 are in the OFF state, and second switches 527 and 533 are in the ON state. At this time, the Gamma reference voltage generator 504 outputs the positive polarity pre-driving voltage Vpre+ to the data line 236 through the switch 527, the Gamma reference voltage generator 504 also outputs the negative polarity pre-driving voltage Vpre− to the data line 237 through the switch 533. Therefore, in the pre-driving period t4, the voltage V236 on the data line 236 pre-rises to the pre-driving voltage Vpre+, and the voltage V237 on the data line 237 pre-lowers to the pre-driving voltage Vpre−. According to the requirements, the person applying the present invention can determine the Gamma reference voltage generator 504 outputs which Gamma reference voltage as the level of the pre-driving voltage Vpre+ and Vpre−.

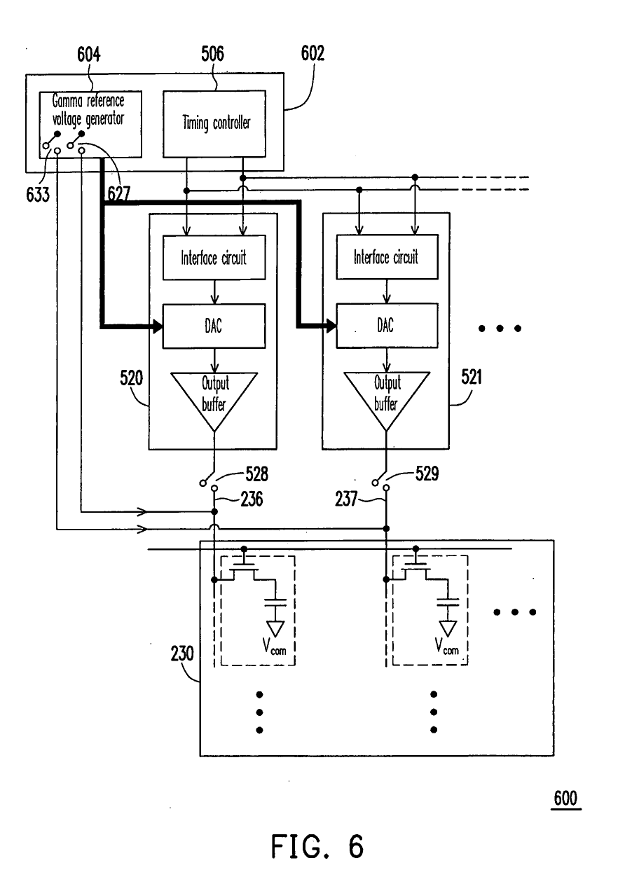

FIG. 6 is another embodiment of a two step driving voltage display according to the present invention. The display 600 of this embodiment is similar to the display 500 of FIG. 5, so the implementing detail is not described. The difference between the display 600 and the display 500 is the implementation of second switches 627 and 633. In the display 500 of FIG. 5, the second switches 527 and 533 and the driver units 520 and 521 are implemented on the same source driver IC. In the display 600 of FIG. 6, the second switches 627 and 633 are implemented in a Gamma reference voltage generator 604. In addition, the second switches 627 and 633 can also be implemented on a control board 602.

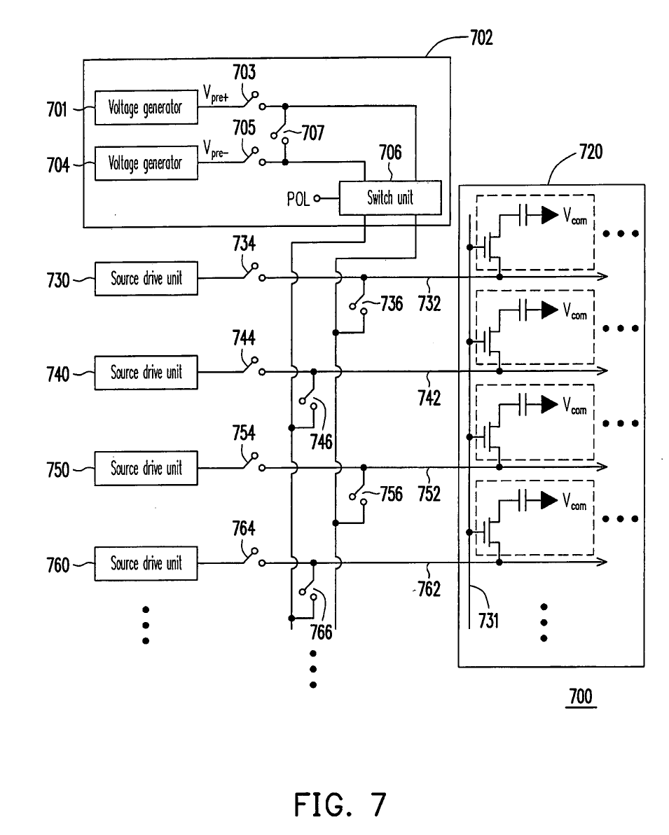

FIG. 7 is a block diagram of a display according to another embodiment of the present invention. The display 700 includes a control board 702, a positive polarity voltage generator 701, a negative polarity voltage generator 704, a switch unit 706, driver units 730, 740, 750, and 760, and a display panel 720. In this embodiment, the switch unit 706 can be implemented as a multiplexer, in addition to be disposed on the control board 702, it can also be formed on a source driving chip. In addition, the display 700 further includes switches 703, 705, 707, 734, 736, 744, 746, 754, 756, 764, and 766. Here, it is assumed that the switches 703 and 705 are in the ON state, and the switch 707 is in the OFF state.

The voltage generators 701 and 704 can be implemented by any means. For example, the Gamma reference voltage generator can be used to realize the voltage generators 701 and 704. In addition, the person applying the present invention can determine the levels of the pre-driving voltages Vpre+ and Vpre+ according to the requirements. For example, the levels of the pre-driving voltages Vpre+ and Vpre− can be set as the level the same as the common voltage Vcom. Alternatively, the level of the pre-driving voltage Vpre+can be set to the level the same as a reference voltage of the positive polarity Gamma reference voltage, and the level of the pre-driving voltages Vpre− can be set to the level the same as a reference voltage of the negative polarity Gamma reference voltage. Alternatively, the pre-driving voltage Vpre+can be set as the minimum positive polarity driving voltage on the scan line, and the pre-driving voltage Vpre− can be set as the maximum negative polarity driving voltage on the scan line.

In the pre-driving period, the first switches 734, 744, 754, and 764 are in the OFF state, and the second switches 736, 746, 756, and 766 are in the ON state. At this time, the voltage generator 701 outputs the positive polarity pre-driving voltage Vpre+ to the switch unit 706 through the switch 703, and the voltage generator 704 also outputs the negative polarity pre-driving voltage Vpre− to the switch unit 706 through the switch 705. According to the control of the polarity signal POL, the switch unit 706 selectively outputs the pre-driving voltage Vpre+ (for example the positive polarity Gamma reference voltage) or the pre-driving voltage Vpre− (for example the negative polarity Gamma reference voltage) to the switches 746 and 766. Relatively, according to the control of the polarity signal POL, the switch unit 706 also selectively outputs the pre-driving voltage Vpre− or the pre-driving voltage Vpre+ to the switches 736 and 756.

Therefore, in the pre-driving period, the voltages on the data lines 732 and 752 pre-rise to the pre-driving voltage Vpre+, and the voltages on the data lines 742 and 762 pre-lower to the pre-driving voltage Vpre−. After the pre-driving period is end, the process proceeds to the data driving period. In the data driving period, the first switches 734, 744, 754, and 764 are in the ON state, and the second switches 736, 746, 756, and 766 are in the OFF state. At this time, the source driver units 730, 740, 750, and 760 convert the image signal to the corresponding data driving voltages, and respectively output the corresponding data driving voltages to the data lines 732, 742, 752, and 762. Therefore, the voltages on the data lines 732 and 752 may be driven to the positive polarity data driving voltage level, and the voltages on the data lines 742 and 762 may be driven to the negative polarity data driving voltage level.

After the data driving period is end, the process proceeds to the next pre-driving period (hereinafter referred to as a second pre-driving period). In the second pre-driving period, the first switches 734, 744, 754, and 764 are in the OFF state, and the second switches 736, 746, 756, and 766 are in the ON state. At this time, according to the control of the polarity signal POL, the switch unit 706 selectively outputs the positive polarity pre-driving voltage Vpre+ to the switches 736 and 756, and outputs the negative polarity pre-driving voltage Vpre− to the switches 746 and 766. Therefore, in the second pre-driving period, the voltages on the data lines 732 and 752 pre-lower to the pre-driving voltage Vpre−, and the voltages on the data lines 742 and 762 pre-rise to the pre-driving voltage Vpre+. Next, in the next data driving period, the voltages on the data lines 732 and 752 may be driven to the negative polarity data driving voltage level, and the voltages on the data lines 742 and 762 may be driven to the positive polarity data driving voltage level, so as to repeatedly perform the same activity.

In addition, the switch 707 is selective. When the switch 707 is turned on, the charge on each data line is uniformly shared. It can be used in the initial time of the pre-driving period, so as to further reduce the power consumption.

In the present invention, in addition to the display, a two step driving method for the display is further provided. For the method, enough teaching, suggestion, and implementation illustration are obtained from the above embodiments, so it is not described.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display, comprising:
a display panel, comprising at least one data line;
a voltage generator, outputting a pre-driving voltage to a data line of the display panel; and
a driver unit, for outputting a data driving voltage to the data line according to an image signal;
wherein the data line receives the pre-driving voltage and the data driving voltage orderly in a horizontal synchronizing period.

2. The display as claimed in claim 1, further comprising a timing controller for controlling the voltage generator to generate the pre-driving voltage.

3. The display as claimed in claim 1, wherein the driver unit further comprises a first switch coupled to the data line, the voltage generator further comprises a second switch coupled to the data line, and the first switch and the second switch are controlled to make the data line receive the pre-driving voltage and the data driving voltage orderly in the horizontal synchronizing period.

4. The display as claimed in claim 1, wherein the voltage generator is a Gamma reference voltage generator of the display.

5. The display as claimed in claim 4, wherein the voltage generator generates a positive polarity Gamma reference voltage or a negative polarity Gamma reference voltage as the pre-driving voltage according to a polarity signal.

6. The display as claimed in claim 5, wherein the voltage generator further comprising a switch unit, for outputting the positive polarity Gamma reference voltage or the negative polarity Gamma reference voltage according to the polarity signal.

7. The display as claimed in claim 6, further comprising:
a second driver unit, for outputting a corresponding second data driving voltage to a second data line of the display panel according to the received image signal;
wherein the voltage generator outputs the positive polarity Gamma reference voltage or the negative polarity reference voltage as a second pre-driving voltage through the switch unit, and the second data line receives the second pre-driving voltage and the second data driving voltage orderly in the horizontal synchronizing period.

8. The display as claimed in claim 1, wherein the pre-driving voltage is a common voltage.

9. The display as claimed in claim 1, wherein the pre-driving voltage is a Gamma reference voltage.

10. The display as claimed in claim 1, wherein the pre-driving voltage is a minimum driving voltage on a scan line of the display panel.

11. The display as claimed in claim 1, further comprising:
a timing controller, for providing the image signal to the driver unit;
wherein the timing controller further outputs the minimum value in the image signal to the voltage generating unit in the horizontal synchronizing period, so as to make the voltage generating unit correspondingly output the pre-driving voltage.

12. The display as claimed in claim 11, wherein the voltage generating unit comprises a digital-analog converter (DAC) for generating the pre-driving voltage according to the output of the timing controller.

13. A two step driving method, for driving a display panel, comprising:
converting an image signal to a corresponding data driving voltage by using a driver unit;
generating a pre-driving voltage by using a voltage generator; and
driving the display panel by using the pre-driving voltage and the data driving voltage orderly in a horizontal synchronizing period.

14. The two step driving method as claimed in claim 13, wherein the pre-driving voltage is a common voltage.

15. The two step driving method as claimed in claim 13, wherein the pre-driving voltage is a Gamma reference voltage.

16. The two step driving method as claimed in claim 13, wherein the step of providing the pre-driving voltage comprises:
selecting a minimum value in the image signal in the horizontal synchronizing period; and
converting the selected minimum value in the image signal to a corresponding voltage to serve as the pre-driving voltage.
